(19) United States
(12) Patent Application Publication
(10) Pub. No.: US 2023/0033948 A1
(43) Pub. Date: Feb. 2, 2023

(54) LIQUID DISCHARGE APPARATUS, LIQUID DISCHARGE METHOD, AND STORAGE MEDIUM

(71) Applicant: Atsushi HADA, Kanagawa (JP)

(72) Inventor: Atsushi HADA, Kanagawa (JP)

(21) Appl. No.: 17/854,030

(22) Filed: Jun. 30, 2022

(30) Foreign Application Priority Data
Jul. 30, 2021 (JP) 2021-126093

(51) Int. Cl. B41J 2/165

(52) U.S. Cl. CPC B41J 2/16579; B41J 2203/01

(57) ABSTRACT

A liquid discharge apparatus includes a recording device and a recording controller. The recording controller alternately performs a main scanning control and a sub-scanning control. The main scanning control controls discharging liquid while moving the recording device and a recording medium relative to each other in a main scanning direction. The sub-scanning control controls the recording device to discharge the liquid from at least two recording elements of the recording device, in accordance with at least two times of the main scanning control performed at positions on the recording medium in a sub-scanning direction. The recording device discharges the liquid, within a range in the sub-scanning direction corresponding to a position of the recording head. The recording controller performs the main scanning control for discharging the liquid based on discharge order mask patterns different from each other in a plurality of regions in the main scanning direction.

### CROSS-REFERENCE TO RELATED APPLICATIONS

This patent application is based on and claims priority pursuant to 35 U.S.C. § 119(a) to Japanese Patent Application No. 2021-126093, filed on Jul. 30, 2021, in the Japan Patent Office, the entire disclosure of which is hereby incorporated by reference herein.

### BACKGROUND

### Technical Field

Embodiments of the present disclosure relate to a liquid discharge apparatus, a liquid discharge method, and a storage medium.

### Related Art

An inkjet recording apparatus that discharges ink onto a recording medium while moving a recording head, in which multiple nozzles for discharging the ink are arranged, and a recording medium relative to each other to form an image is known in the art as an example of a liquid discharge apparatus. In such an inkjet recording apparatus, a technology is known for forming an image by alternately repeating a main scanning operation for discharging ink from multiple nozzles onto a recording medium while moving a recording head in a main scanning direction and a sub-scanning operation for moving the recording head or the recording medium in a sub-scanning direction.

For inkjet recording apparatuses, a technology has been developed that complements an ink discharge failure of a nozzle, which is caused by damage to a recording head, with an alternative nozzle to reduce white stripes generated in an image formed on a recording medium.

### SUMMARY

In an embodiment of the present disclosure, a liquid discharge apparatus includes a recording device and a recording controller. The recording device includes a recording head arranged to extend in a sub-scanning direction. The recording head includes a plurality of recording elements that discharges liquid. At least some of the plurality of recording elements constitute a plurality of sub-recording element groups. The recording controller alternately performs a main scanning control and a sub-scanning control. The main scanning control controls discharging the liquid from the plurality of recording elements to a recording medium while moving the recording device and the recording medium relative to each other in a main scanning direction intersecting with the sub-scanning direction. The sub-scanning control controls moving the recording device and the recording medium relative to each other in the sub-scanning direction to control the recording device to discharge the liquid from at least two of the plurality of recording elements, in accordance with at least two times of the main scanning control performed at positions on the recording medium in the sub-scanning direction, to record an image on the recording medium. The recording device discharges the liquid to the recording medium, within a range in the sub-scanning direction corresponding to a position of the recording head, from recording elements of each of the plurality of sub-recording element groups. The recording controller performs the main scanning control for discharging the liquid from each of the plurality of sub-recording element groups based on discharge order mask patterns different from each other in a plurality of regions in the main scanning direction.

In another embodiment of the present disclosure, a liquid discharge method for a recording device including a recording head arranged to extend in a sub-scanning direction. The recording head includes a plurality of recording elements to discharge liquid and at least some of the plurality of recording elements constitute a plurality of sub-recording element groups. The method includes discharging the liquid, performing a main scanning control and a sub-scanning control, and performing the main scanning control. The discharging discharges the liquid to a recording medium, within a range in the sub-scanning direction corresponding to a position of the recording head, from recording elements of each of the plurality of sub-recording element groups. The performing the main scanning control and the sub-scanning control alternately performs the main scanning control and the sub-scanning control. The main scanning control controls discharging the liquid from the plurality of recording elements to a recording medium while moving the recording device and the recording medium relative to each other in a main scanning direction intersecting with the sub-scanning direction. The sub-scanning control controls moving the recording device and the recording medium relative to each other in the sub-scanning direction to control the recording device to discharge the liquid from at least two of the plurality of recording elements, in accordance with at least two times of the main scanning control performed at positions on the recording medium in the sub-scanning direction, to record an image on the recording medium. The performing the main scanning control controls discharging the liquid from each of the plurality of sub-recording element groups based on discharge order mask patterns different from each other in a plurality of regions in the main scanning direction.

In still another embodiment of the present disclosure, a non-transitory storage medium storing program code that causes one or more processors to control a liquid discharge apparatus including a recording device to execute a process. The recording device includes a recording head arranged to extend in a sub-scanning direction. The recording head includes a plurality of recording elements to discharge liquid. At least some of the plurality of recording elements constitute a plurality of sub-recording element groups. The process includes discharging the liquid, alternately performing a main scanning control and a sub-scanning control, and performing the main scanning control. The discharging discharges the liquid to a recording medium, within a range in the sub-scanning direction corresponding to a position of the recording head, from recording elements of each of the plurality of sub-recording element groups. The performing the main scanning control and the sub-scanning control alternately performs the main scanning control and the sub-scanning control. The main scanning control controls discharging the liquid from the plurality of recording elements to a recording medium while moving the recording device and the recording medium relative to each other in a main scanning direction intersecting with the sub-scanning direction. The sub-scanning control controls moving the recording device and the recording medium relative to each other in the sub-scanning direction to control the recording device to discharge the liquid from at least two of the plurality of recording elements, in accordance with at least two times of the main scanning control performed at positions on the recording medium in the sub-scanning direction, to record an image on the recording medium. The performing the main scanning control controls discharging the liquid from each of the plurality of sub-recording element groups based on discharge order mask patterns different from each other in a plurality of regions in the main scanning direction.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein.

FIG. 1 is a perspective view of a liquid discharge apparatus provided for an image forming system, according to a first embodiment of the present disclosure;

FIG. 2 is a diagram illustrating a configuration of a head device provided for the liquid discharge apparatus according to the first embodiment of the present disclosure;

FIG. 3 is a functional block diagram illustrating a hardware configuration of the liquid discharge apparatus according to the first embodiment of the present disclosure:

FIG. 4 is a functional block diagram illustrating a configuration of a controller provided for the liquid discharge apparatus according to the first embodiment of the present disclosure:

FIG. 5 is a diagram illustrating an example of image forming processing performed by a general image forming system:

FIG. 6 is a diagram illustrating an example of image recording processing performed by the liquid discharge apparatus according to the first embodiment of the present disclosure:

FIG. 7 is a diagram illustrating an example of image recording processing performed by the liquid discharge apparatus according to the first embodiment of the present disclosure;

FIG. 8 is a diagram illustrating an example of image recording processing performed by a liquid discharge apparatus according to a second embodiment of the present disclosure; and

FIG. 9 is a diagram illustrating other example of image recording processing performed by the liquid discharge apparatus according to the second embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an image forming system to which a liquid discharge apparatus, a liquid discharge method, and a program are applied are described in detail with reference to the accompanying drawings in the following description.

### First Embodiment

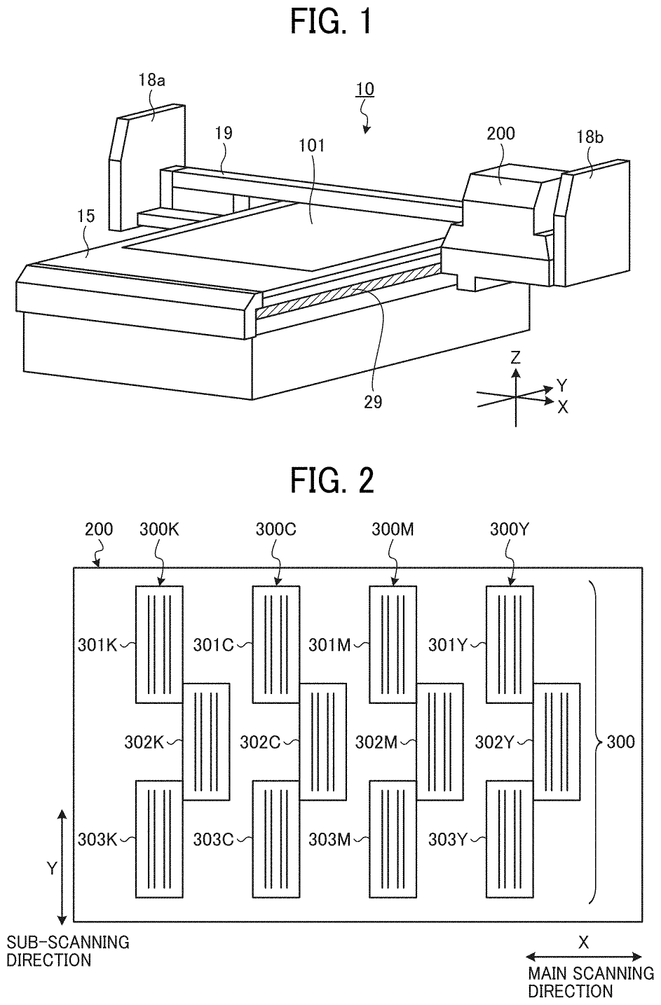

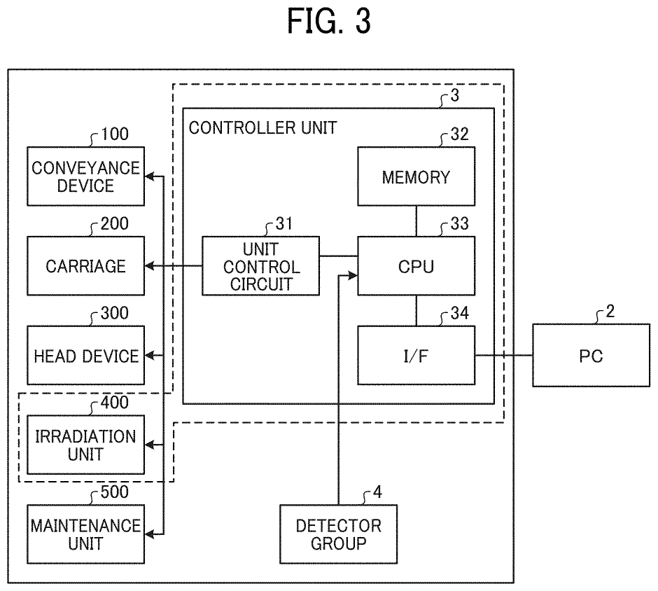

FIG. 1 is a perspective view of a liquid discharge apparatus 10 provided for an image forming system, according to a first embodiment of the present disclosure. As illustrated in FIG. 1, the liquid discharge apparatus 10 according to the first embodiment includes a platen 15 on which a printing target 101, such as a sheet of paper as an example of a recording medium, is placed, a left-side plate 18a, a right-side plate 18b, a guide rod 19, a guide rail 29, a carriage 200, and an irradiation unit 400 (see FIG. 3).

Among the above-described components, the carriage 200 includes head units 300K, 300C, 300M, and 300Y (see FIG. 2). The head unit 300K discharges black (K) ink, and the head unit 300C discharges cyan (C) ink. The head unit 300M discharges magenta (M) ink, and the head unit 300Y discharges yellow (Y) ink. Note that the head units 300K, 300C. 300M, and 300Y are collectively referred to as a head device 300 (see FIG. 3) unless otherwise distinguished in the following description.

The carriage 200 is supported by the guide rod 19 bridged between the left-side plate 18a and the right-side plate 18b and movable in an X direction, i.e., a main scanning direction. The carriage 200 is also movable in a Z direction, i.e., a vertical direction, by a lifting mechanism.

Further, the carriage 200, the guide rod 19, the left-side plate 18a, and the right-side plate 18b may be integrally movable in a Y direction, i.e., a sub-scanning direction along the guide rail 29 disposed under the platen 15.

The irradiation unit 400 (see FIG. 3) is disposed on a side of the carriage 200 facing the printing target 101 and irradiates ultraviolet rays to ink discharged from the head device 300 (see FIG. 3) and landed on the printing target 101. The ink on the printing target 101 is cured by the irradiation of the ultraviolet rays. The irradiation unit 400 (see FIG. 3) may include an ultraviolet (UV) irradiation lamp for irradiating UV light.

In FIG. 1, a configuration example is illustrated in which the carriage 200 can move in the main scanning direction and the sub-scanning direction. However, embodiments of the present disclosure are not limited to such a configuration as long as the head device 300 (see FIG. 3) and the printing target 101 can be moved relative to each other in the main scanning direction and the sub-scanning direction. For example, the carriage 200 may be moved in the main scanning direction and the printing target 101 may be moved in the sub-scanning direction. Alternatively, the printing target 101 may be moved in the main scanning direction and the sub-scanning direction.

Next, a configuration of the head device 300 is described with reference to FIG. 2. FIG. 2 is a diagram illustrating a configuration example of the head device 300 provided for the liquid discharge apparatus 10 and the carriage 200 viewed from the printing target 101, i.e., viewed from below, according to the first embodiment of the present disclosure.

As illustrated in FIG. 2, the head units 300K, 300C, 300M, and 300Y are arranged in the main scanning direction in the carriage 200.

As a recording head for discharging K ink, the head unit 300K includes sub-recording heads 301K, 302K, and 303K divided as three individual units in the sub-scanning direction and arranged at different positions in the sub-scanning direction. Each of the sub-recording heads 301K, 302K and 303K included in the head unit 300K as the recording head includes multiple nozzles as an example of recording elements arranged in the sub-scanning direction. In other words, the head unit 300K includes the multiple sub-recording heads 301K, 302K, and 303K divided in the sub-scanning direction.

As illustrated in FIG. 2, the sub-recording head 302K is disposed slightly shifted from the sub-recording heads 301K and 303K in the main scanning direction, and the sub-recording heads 301K, 302K and 303K are disposed so as to overlap each other in the sub-scanning direction. In other words, the sub-recording heads 301K, 302K, and 303K are arranged in a staggered manner. Such an arrangement of the sub-recording heads 301K, 302K, and 303K as described above prevents absence of nozzles between the sub-recording heads 301K and 302K and between the sub-recording head 302K and 303K in the sub-scanning direction.

The configurations of the head units 300C, 300M, and 300Y are similar to the configuration of the head unit 300K except for color of the ink discharged by the head units 300C, 300M, and 300Y. Accordingly, redundant description thereof is omitted. In the present embodiment, the head device 300 as an example of a recording device includes the recording heads extending in the sub-scanning direction, and at least a part of the multiple nozzles serves as a sub-recording element group. The head device 300 discharges ink to the printing target 101 through the nozzles of the sub-recording element group of the recording heads within a range in which the recording heads are arranged in the sub-scanning direction.

In the present embodiment, the head device 300 includes three sub-recording heads arranged in the sub-scanning direction in each of the head units 300K, 300C, 300M, and 300Y. However, the number of sub-recording heads arranged in the sub-scanning direction is not limited to three. In the head device 300, two or four or more sub-recording heads can be arranged in the sub-scanning direction. Further, a single recording head that is not divided in the sub-scanning direction can also be employed as the recording head.

Each of the head units 300K, 300C, 300M, and 300Y of the head device 300 includes piezoelectric elements that serve as pressure generators. Each of the piezoelectric elements contracts in response to a drive signal and discharges ink as an example of liquid by a pressure change generated in accordance with the contraction of the piezoelectric element.

The ink according to the present embodiment is UV curable and may be, for example, ink containing a methacrylate monomer. A methacrylate monomer has characteristics of relatively weak skin sensitization and large cure shrinkage.

Next, a hardware configuration of the liquid discharge apparatus 10 is described. FIG. 3 is a functional block diagram illustrating a hardware configuration of the liquid discharge apparatus 10 according to the first embodiment of the present disclosure.

As illustrated in FIG. 3, the liquid discharge apparatus 10 includes a controller unit 3, a detector group 4, a conveyance device 100, the carriage 200, the head device 300, the irradiation unit 400, and a maintenance unit 500.

The controller unit 3 includes a unit control circuit 31, a memory 32, a central processing unit (CPU) 33, and an interface (I/F) 34. In the present embodiment, as indicated by a broken line in FIG. 3, the controller unit 3 and the irradiation unit 400 serve as a curing apparatus for curing ink on the printing target 101.

The I/F 34 is an interface for connecting the liquid discharge apparatus 10 and a personal computer (PC) 2 as an external device. The liquid discharge apparatus 10 may be directly connected to the PC 2 in any manner, and the liquid discharge apparatus 10 and the PC 2 may be connected to each other, for example, through a network or a communication cable.

The CPU 33 uses the memory 32 as a working area to control each of the components of the liquid discharge apparatus 10 via the unit control circuit 31. More specifically, the CPU 33 controls each of the components of the liquid discharge apparatus 10 based on image data received from the PC 2 and data detected by the detector group 4 to record an image on the printing target 101.

The detector group 4 is a variety of sensors provided for the liquid discharge apparatus 10 such as an encoder sensor for detecting the position of the carriage 200 in the main scanning direction.

A printer driver is installed in the PC 2, and image data to be transmitted to the liquid discharge apparatus 10 is generated from raw image data by the printer driver. The image data generated by the printer driver includes command data for operating, for example, the carriage 200 of the liquid discharge apparatus 10 and pixel data relating to an image to be recorded.

The conveyance device 100 includes a conveyance mechanism for conveying the printing target 101.

The maintenance unit 500 includes a maintenance and recovery mechanism for a discharge function of each of the head units 300K, 300C. 300M, and 300Y of the head device 300. The maintenance and recovery mechanism includes caps for covering nozzle surfaces of the head units 300K, 300C. 300M, and 300Y to protect the nozzles from drying during a period in which the liquid discharge apparatus 10 does not perform recording.

The caps include a moisturizing cap and a suction cap. The moisturizing cap only covers the nozzle surface and has a function only to protect the nozzle surface from drying. The suction cap is connected to a suction pump and sucks thickened ink from the recording head in addition to the function of the moisturizing cap.

Next, an operation of recording an image on a recording medium by the liquid discharge apparatus 10 is described.

First, based on a drive signal from the CPU 33, the carriage 200 moves in the Y-axis direction, i.e., the sub-scanning direction and stops at an initial position for recording an image.

Subsequently, the lifting mechanism is driven based on a drive signal from the CPU 33 to move the carriage 200 to a height suitable for discharging ink by the head device 300. The height of the carriage 200 suitable for discharging ink by the head device 300 is, for example, a height at which the gap between the printing target 101 and the nozzles of the recording heads is 1 mm. Preferably, the lifting mechanism is driven and controlled based on a detection signal from a height sensor that detects the height of the head device 300.

Subsequently, the carriage 200 reciprocates in the main scanning direction based on a drive signal from the CPU 33. During a period in which the carriage 200 reciprocates in the main scanning direction, the head device 300 discharges ink based on the drive signal from the CPU 33. Accordingly, an image for one scanning in the main scanning direction is recorded on the printing target 101.

Subsequently, the carriage 200 moves by one scanning in the sub-scanning direction based on a drive signal from the CPU 33.

A main scanning control for recording an image for one scanning in the main scanning direction and a sub-scanning control for moving the carriage 200 for one scanning in the sub-scanning direction are performed alternately until recording of an image on the printing target 101 is completed.

When the recording of the image on the printing target 101 is completed, the printing target 101 stands by until the ink is smoothed. After the ink is smoothed, the UV light is irradiated from the irradiation unit 400, and the ink on the printing target 101 is cured. Accordingly, the image is fixed on the printing target 101.

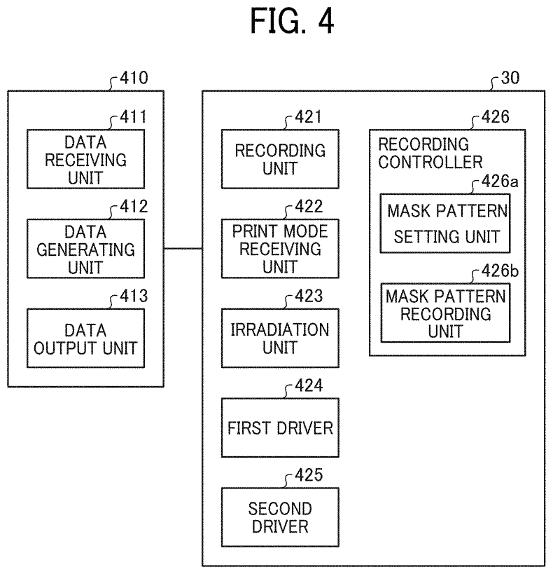

Next, the functional configuration of the controller unit 3 provided for the liquid discharge apparatus 10 is described. FIG. 4 is a functional block diagram illustrating a configuration of the controller unit 3 provided for the liquid discharge apparatus 10 according to the first embodiment of the present disclosure. As illustrated in FIG. 4, the controller unit 3 includes an image processing unit 410 and a controller 30.

The image processing unit 410 includes a data receiving unit 411, a data generating unit 412, and a data output unit 413.

The data receiving unit 411 receives image data from the PC 2. The image data includes information such as a shape and a color of an image to be formed.

The data generating unit 412 performs predetermined data processing such as CMYK conversion processing, gradation reduction processing and image conversion processing on image data received by the data receiving unit 411. Thus, the data generating unit 412 generates recording data to be recorded on the printing target 101 based on the image data.

The data output unit 413 outputs the generated recording data to the controller 30.

The controller 30 includes a recording unit 421, a print mode receiving unit 422, an irradiation unit 423, a first driver 424, a second driver 425, and a recording controller 426.

The recording unit 421 is a head driver that is controlled by the recording controller 426 and causes the head device 300 to discharge ink.

The print mode receiving unit 422 receives data relating to a print mode. The irradiation unit 423 controls the irradiation of UV light onto the printing target 101 by the irradiation unit 400.

The first driver 424 moves the carriage 200 in the main scanning direction. The second driver 425 moves the carriage 200 in the sub-scanning direction.

The recording controller 426 receives recording data from the image processing unit 410. The recording controller 426 controls the recording unit 421, the first driver 424, the second driver 425, and the irradiation unit 400 such that ink corresponding to each pixel of print data is discharged from each of the head units 300K, 300C, 300M, and 300Y of the head device 300 in accordance with the received recording data.

In the present embodiment, the recording controller 426 includes a mask pattern setting unit 426a and a mask pattern storage unit 426b.

Among the above-described components, the mask pattern setting unit 426a sets a mask thinning-out pattern (hereinafter referred to as a discharge order mask pattern) to a predetermined state and stores the discharge order mask pattern in the mask pattern storage unit 426b implemented by, for example, the memory 32. More specifically, as an example, the mask pattern setting unit 426a inputs via the I/F 34 the discharge order mask pattern, which is generated or edited to the predetermined state by an administrator or a user of the liquid discharge apparatus 10 via an input interface such as a mouse or a keyboard of the PC 2, and stores in the mask pattern storage unit 426b.

In the present embodiment, the recording controller 426 acquires the discharge order mask pattern from the mask pattern storage unit 282 and executes mask processing. In the present embodiment, the mask processing is processing for generating thinned image data in which only valid pixels are extracted from image data to be recorded by a logical conjunction of the image data to be recorded and a discharge order mask pattern by using a discharge order mask pattern to designate the valid pixels that are allowed to be recorded on the printing target 101.

Among the pixels included in the image data, pixels that correspond to the valid pixels are pixels to be recorded on the printing target 101. Invalid pixels that do not correspond to the valid pixels are pixels that are not to be recorded in the printing target 101. Accordingly, the mask processing as described above allows a part of the pixels included in the raw image data to be invalidated and thinned. Thus, thinned image data can be obtained.

The recording controller 426 causes the head units 300K, 300M, 300C, and 300Y to discharge ink based on the thinned image data. Accordingly, a thinned image, which is obtained by thinning a portion corresponding to invalid pixels from the raw image data, is recorded on the printing target 101.

More specifically, the recording controller 426 alternately executes the main scanning control and the sub-scanning control. Thus, the recording controller 426 controls the head units 300K, 300M, 300C, and 300Y so that ink is discharged from at least two nozzles at a position in the sub-scanning direction of the printing target 101 in accordance with at least two times of the main scanning control. Thus, the recording controller 426 records an image on the printing target 101.

In the present embodiment, the main scanning control is a control for discharging ink from the nozzles to the printing target 101 while moving the recording heads and the printing target 101 relative to each other in the main scanning direction. The sub-scanning control is a control for moving the head device 300 and the printing target 101 relative to each other in the sub-scanning direction. In other words, the recording controller 426 executes the main scanning control and the sub-scanning control multiple times such that invalidated pixels are complemented with ink both in the main scanning direction and in the sub-scanning direction to record thinned images on the printing target 101 and the recorded thinned images are combined. Accordingly, an image is recorded on the printing target 101.

In addition, the recording controller 426 executes the main scanning control for discharging ink from each of the multiple sub-recording element groups based on discharge order mask patterns different from each other in multiple regions in the main scanning direction. Accordingly, a discharge order mask pattern having a low usage rate of the nozzle is applied to a nozzle in which a discharge failure has occurred. Thus, the visibility of the white stripes generated in the printing target 101 can be reduced.

In the present embodiment, the discharge order mask pattern is set for each of the head units 300K, 300C, 300M, and 300Y of the head device 300. Further, the discharge order mask pattern set for each of the head units 300K, 300C, 300M, and 300Y of the head device 300 is set for each of multiple regions in the sub-scanning direction. When one region and another region in the main scanning direction are compared with each other, the discharge order mask pattern is exchanged in a part of the multiple regions in the sub-scanning direction. Accordingly, a different discharge order mask pattern is set for each of the multiple regions in the main scanning direction of the printing target 101. Thus, the visibility of white stripes in the main scanning direction can be reduced.

For example, it is assumed that the discharge order mask pattern set for each of the head units 300K, 300C, 300M, and 300Y of the head device 300 is exchanged in a region having a relatively-large average discharge amount of ink among the multiple regions in the sub-scanning direction. Such a configuration as described above allows a discharge order mask pattern with a low usage rate of the nozzle to be applied to a nozzle with a large discharge amount of ink, which is likely to cause a discharge failure. Thus, the visibility of white stripes generated in the printing target 101 can be reduced.

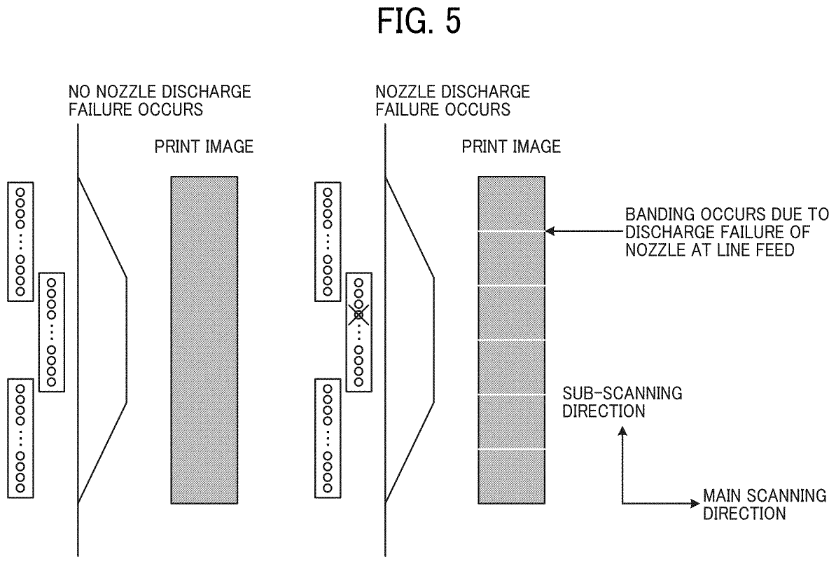

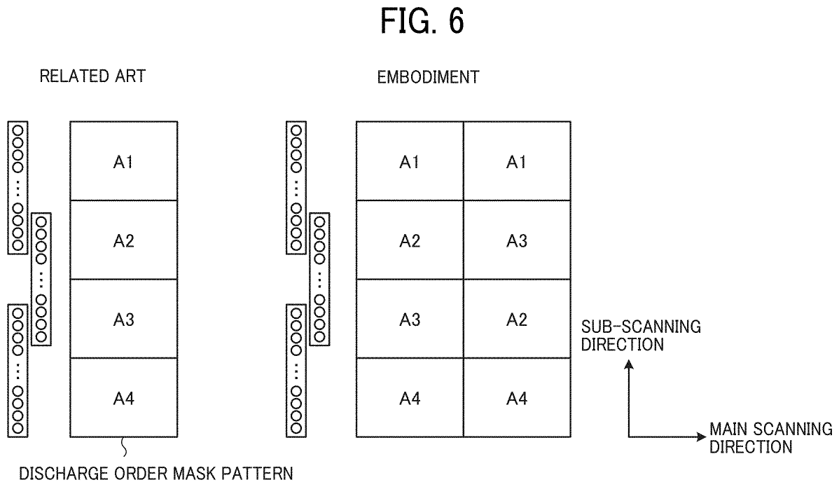

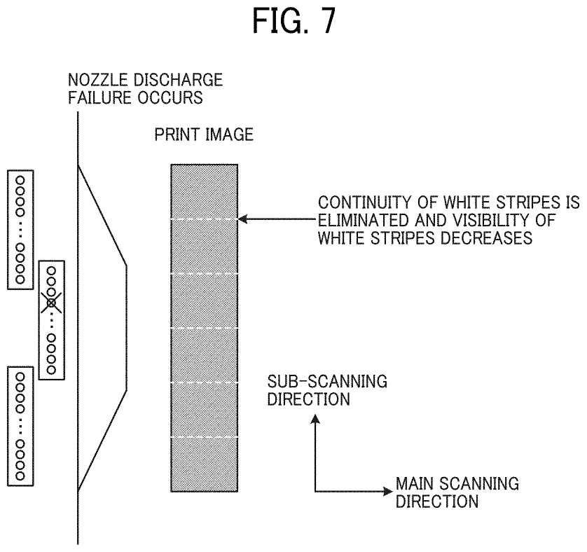

FIG. 5 is a diagram illustrating image forming processing performed by a general image forming system. FIGS. 6 and 7 are diagrams illustrating image recording processing performed by the liquid discharge apparatus according to the first embodiment of the present disclosure. Next, an example of image recording processing in the liquid discharge apparatus 10 according to the present embodiment is described with reference to FIGS. 5, 6, and 7.

In an image forming system known in the art, an image is formed by using a discharge order mask pattern. The discharge order mask pattern is used to control a printing rate, i.e., the amount of ink droplets to be discharged, of each nozzle of the recording head. For example, using the discharge order mask pattern allows the printing rate to be changed stepwise or nozzles that discharge ink to be thinned out at random. Accordingly, characteristic patterns and unevenness that appear on a formed image, i.e., printed image, can be reduced.

In an image forming system known in the art, as illustrated in the left side of FIG. 5, an image may be formed by applying a discharge order mask pattern inclined at both ends in the sub-scanning direction to a nozzle array of a recording head. In this case, the printing rate, i.e., the number of times of discharging ink droplets, of nozzles at both ends in the sub-scanning direction is reduced. Accordingly, the printing rate of nozzles in a center region in the sub-scanning direction is increased. However, in the above-described discharge order mask pattern, as illustrated in the right side of FIG. 5, when non-discharge of ink from a nozzle, i.e., a discharge failure of a nozzle, occurs, white stripes appear remarkably in the main scanning direction, and the image quality is deteriorated.

More specifically, in an image forming system known in the art, as illustrated in the left side of FIG. 6, multiple groups of discharge order mask patterns are formed as discharge order mask patterns A1, A2, A3, and A4 with respect to the nozzle array of the recording head. In the image forming system known in the art, each group of the discharge order mask patterns A1, A2, A3, and A4 overlaps and complements each other to form a single image.

Further, in the image forming system known in the art, changing the amount of ink discharge from nozzles in each nozzle group allows reduction of the usage rate of nozzles at ends in the nozzle group at which the image quality tends to deteriorate. For example, in the image forming system known in the art, as illustrated in FIG. 5, providing the nozzle array of the recording head that is inclined at both ends in the sub-scanning direction allows reduction of the usage rate of the nozzles at both ends at which the image quality tends to deteriorate.

On the other hand, in the image forming system known in the art, when a nozzle array corresponding to a nozzle group having a large amount of ink discharge is clogged, outstanding white stripes are likely to be generated. For example, as illustrated in the left side of FIG. 6, in the image forming system known in the art, when discharge order mask patterns having similar ink discharge amount distribution continues in the main scanning direction, outstanding white stripes appear with respect to the main scanning direction when a nozzle array at the center region in the sub-scanning direction is clogged.

On the other hand, in the liquid discharge apparatus 10 according to the present embodiment, as illustrated in the right side of FIG. 6, the recording controller 426 changes the discharge order mask pattern used in two times of the main scanning control at each position in the sub-scanning direction of the printing target 101. For example, as illustrated in the right side of FIG. 6, the recording controller 426 exchanges a discharge order mask pattern A2 with a discharge order mask pattern A3 used in two times of the main scanning control at a center region of the printing target 101 in the sub-scanning direction.

Accordingly, as illustrated in FIG. 7, the discharge order mask pattern A2 corresponding to nozzles of a recording head in which the discharge failure has occurred has a high usage rate, i.e., a large discharge amount of ink, of the nozzle in which the discharge failure has occurred. Accordingly, if the discharge order mask pattern A2 is continuously used in the main scanning direction, the visibility of the white stripes is high. However, according to the liquid discharge apparatus 10 of the present embodiment, applying the discharge order mask pattern A3 having a low usage rate of a nozzle in which the discharge failure has occurred to the nozzle allows reduction of the visibility of the white stripes generated in the printing target 101.

In other words, in the present embodiment, as illustrated in the right side of FIG. 6, the recording controller 426 exchanges a discharge order mask pattern corresponding to a nozzle array in a center region in the sub-scanning direction among nozzles of the recording head in multiple regions in the main scanning direction. Accordingly, as illustrated in FIG. 7, even if non-discharge of ink from nozzles, i.e., ink discharge failure of nozzles of the recording head, occurs, the continuity of white stripes generated on the printing target 101 can be eliminated. Accordingly, the white stripes are unlikely to be recognized as abnormal in an image recorded on the printing target 101, and the visibility of the white stripes can be reduced.

For example, the recording controller 426 may determine a group of nozzles of the recording head for which the discharge order mask pattern is to be exchanged according to the amount of ink discharge of the nozzle group. For example, in the example illustrated in FIG. 5, among the nozzles of the recording head, the amount of ink discharge from nozzles in a center region in the sub-scanning direction is increased. The visibility of the white stripes generated on the printing target 101 is proportional to the amount of ink discharge of the nozzle, and the visibility of the white stripes increases as the amount of ink discharge of the nozzle increases.

Accordingly, the recording controller 426 exchanges the discharge order mask pattern (for example, discharge order mask patterns A2 and A3) used for a group of nozzles, which is a sub-recording element group having a large discharge amount of ink among nozzles of the recording head. On the other hand, the recording controller 426 does not exchange the discharge order mask pattern (for example, the discharge order mask patterns A1 and A4) used for the group of nozzles, which is a sub-recording element group, having a small amount of ink discharge among the nozzles of the recording head.

As described above, according to the liquid discharge apparatus 10 according to the first embodiment, the main scanning control for discharging ink from each of the multiple sub-recording element groups is executed based on the discharge order mask patterns different from each other in multiple regions in the main scanning direction. Accordingly, a discharge order mask pattern having a low usage rate of the nozzle is applied to a nozzle in which a discharge failure has occurred. Thus, the visibility of the white stripes generated in the printing target 101 can be reduced.

### Second Embodiment

A second embodiment of the present disclosure is an example in which different discharge order mask patterns are set in adjacent columns of regions in the main scanning direction. In the following description, the description of a configuration similar to that of the first embodiment is omitted.

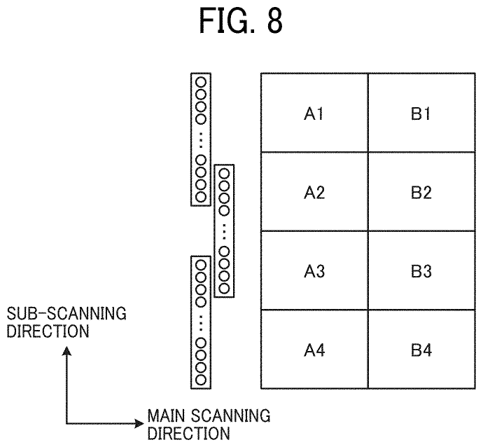

FIG. 8 is a diagram illustrating image recording processing performed by the liquid discharge apparatus 10, according to the second embodiment. In the present embodiment, as illustrated in FIG. 8, the recording controller 426 sets a discharge order mask pattern, which is different from a discharge order mask pattern set to a first column among the columns of regions in the main scanning direction of the printing target 101, to a second column adjacent to the first column among the columns of regions in the main scanning direction of the printing target 101. Accordingly, a different discharge order mask pattern is set for each of the multiple regions in the main scanning direction of the printing target 101. Thus, the visibility of white stripes in the main scanning direction can be reduced.

For example, as illustrated in FIG. 8, the recording controller 426 sets the discharge order mask patterns A1, A2, A3, and A4 for the first column of regions in the main scanning direction of the printing target 101. On the other hand, as illustrated in FIG. 8, the recording controller 426 sets the discharge order mask patterns B1, B2, B3, and B4 different from the discharge order mask patterns A1, A2, A3, and A4, respectively, for the second column adjacent to the first column among the columns of regions in the main scanning direction of the printing target 101.

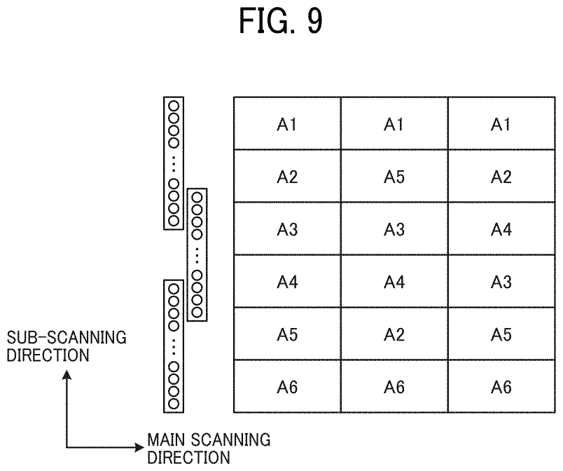

FIG. 9 is a diagram illustrating other image recording processing performed by the liquid discharge apparatus 10, according to the second embodiment of the present disclosure. In the present embodiment, as illustrated in FIG. 9, the recording controller 426 can also exchange the discharge order mask patterns in different regions between adjacent columns in the main scanning direction of the printing target 101.

For example, among the columns of regions in the main scanning direction of the printing target 101, in a second column from the left as viewed facing the drawing, the recording controller 426 exchanges the discharge order mask pattern A2 with the discharge order mask pattern A5 as compared with the first column. Further, for example, among the columns of regions in the main scanning direction of the printing target 101, the recording controller 426 exchanges the discharge order mask pattern A3 with the discharge order mask pattern A4 in a third column from the left as viewed facing the drawing, as compared with the second column.

Further, as illustrated in FIG. 9, the recording controller 426 may increase the number of discharge order mask patterns used for controlling ink discharge from the nozzles of the recording head to six discharge order mask patterns A1, A2, A3, A4, A5, and A6. Then, as illustrated in FIG. 9, the recording controller 426 can also increase combinations of exchange of the discharge order mask patterns in regions different from each other between columns adjacent to each other in the main scanning direction of the printing target 101.

As described above, in the liquid discharge apparatus 10 according to the second embodiment of the present disclosure, a discharge order mask pattern different from the discharge order mask pattern set on the first column in the columns of regions of the printing target 101 in the main scanning direction is set on the second column adjacent to the first column among the columns of regions of the printing target 101 in the main scanning direction. Accordingly, a different discharge order mask pattern is set for each of the multiple regions in the main scanning direction of the printing target 101. Thus, the visibility of white stripes in the main scanning direction can be reduced.

Note that a program executed by the liquid discharge apparatus 10 according to the above-described embodiments of the present disclosure is pre-installed in a read only memory (ROM) and provided. The program executed by the liquid discharge apparatus 10 according to the above-described embodiments of the present disclosure may be recorded on a computer-readable recording medium such as a compact disk read only memory (CD-ROM), a flexible disk (FD), a compact disc recordable (CD-R), or a digital versatile disk (DVD) as an installable or executable file and provided.

Further, a program executed by the liquid discharge apparatus 10 according to the above-described embodiments of the present disclosure may be stored on a computer connected to a network such as the Internet and downloaded via the network to provide the program. A program executed by the liquid discharge apparatus 10 according to the above-described embodiments of the present disclosure may be provided or distributed via a network such as the Internet.

The program executed by the liquid discharge apparatus 10 according to the above-described embodiments of the present disclosure has a module configuration including the above-described components (the image processing unit 410 and the controller 30). In terms of actual hardware, the CPU 33 as an example of a processor, reads the program from the memory 32 such as ROM and executes the program, and thus the components are loaded onto the main storage device and the image processing unit 310 and the controller 30 are generated on the main storage device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. A liquid discharge apparatus comprising:
a recording device including a recording head arranged to extend in a sub-scanning direction, the recording head including a plurality of recording elements configured to discharge liquid, at least some of the plurality of recording elements constituting a plurality of sub-recording element groups; and
a recording controller configured to alternately perform:
a main scanning control for discharging the liquid from the plurality of recording elements to a recording medium while moving the recording device and the recording medium relative to each other in a main scanning direction intersecting with the sub-scanning direction, and
a sub-scanning control for moving the recording device and the recording medium relative to each other in the sub-scanning direction to control the recording device to discharge the liquid from at least two of the plurality of recording elements, in accordance with at least two times of the main scanning control performed at positions on the recording medium in the sub-scanning direction, to record an image on the recording medium,
wherein the recording device is configured to discharge the liquid to the recording medium, within a range in the sub-scanning direction corresponding to a position of the recording head, from recording elements of each of the plurality of sub-recording element groups, and
wherein the recording controller is configured to perform the main scanning control for discharging the liquid from each of the plurality of sub-recording element groups based on discharge order mask patterns different from each other in a plurality of regions in the main scanning direction.

2. The liquid discharge apparatus according to claim 1,
wherein the discharge order mask patterns are set for a plurality of regions in the sub-scanning direction in one-to-one correspondence,
wherein the discharge order mask patterns are set for a first column of regions arranged in the sub-scanning direction and a second column of regions arranged in the sub-scanning direction, the first column and the second column are adjacent to each other in the main scanning direction, and
wherein positions of the discharge order mask patterns in the sub-scanning direction are partially exchanged between the first column and the second column.

3. The liquid discharge apparatus according to claim 2,
wherein the discharge order mask patterns are exchanged between a first region and a second region among the plurality of regions in the sub-scanning direction, and the first region has a larger average discharge amount than the second region.

4. The liquid discharge apparatus according to claim 1,
wherein the discharge order mask patterns include discharge order mask patterns set to a first column of regions arranged in the sub-scanning direction and discharge order mask patterns set to a second column of regions arranged in the sub-scanning direction, and the first column and the second column are adjacent to each other in the main scanning direction, and
wherein the discharge order mask patterns set to the first column are different from the discharge order mask patterns set to the second column.

5. The liquid discharge apparatus according to claim 2,
wherein the discharge order mask patterns are further set for a third column of regions arranged in the sub-scanning direction,
wherein the second column and the third column are adjacent to each other in the main scanning direction, and
wherein the positions of the discharge order mask patterns in the sub-scanning direction partially exchanged between the first column and the second column are different from positions of the discharge order mask patterns in the sub-scanning direction partially exchanged between the second column and the third column.

6. The liquid discharge apparatus according to claim 1,
wherein the recording head includes a plurality of sub-recording heads divided in the sub-scanning direction.

7. A liquid discharge method for a recording device including a recording head arranged to extend in a sub-scanning direction, the recording head including a plurality of recording elements configured to discharge liquid, at least some of the plurality of recording elements constituting a plurality of sub-recording element groups, the method comprising:
discharging the liquid to a recording medium, within a range in the sub-scanning direction corresponding to a position of the recording head, from recording elements of each of the plurality of sub-recording element groups;
alternately performing:
a main scanning control for discharging the liquid from the plurality of recording elements to a recording medium while moving the recording device and the recording medium relative to each other in a main scanning direction intersecting with the sub-scanning direction; and
a sub-scanning control for moving the recording device and the recording medium relative to each other in the sub-scanning direction to control the recording device to discharge the liquid from at least two of the plurality of recording elements, in accordance with at least two times of the main scanning control performed at positions on the recording medium in the sub-scanning direction, to record an image on the recording medium; and
performing the main scanning control for discharging the liquid from each of the plurality of sub-recording element groups based on discharge order mask patterns different from each other in a plurality of regions in the main scanning direction.

8. A non-transitory storage medium storing program code that causes one or more processors to control a liquid discharge apparatus including a recording device to execute a process, the recording device including a recording head arranged to extend in a sub-scanning direction, the recording head including a plurality of recording elements configured to discharge liquid, at least some of the plurality of recording elements constituting a plurality of sub-recording element groups, the process comprising:
discharging the liquid to a recording medium, within a range in the sub-scanning direction corresponding to a position of the recording head, from recording elements of each of the plurality of sub-recording element groups;
alternately performing:
a main scanning control for discharging the liquid from the plurality of recording elements to a recording medium while moving the recording device and the recording medium relative to each other in a main scanning direction intersecting with the sub-scanning direction; and
a sub-scanning control for moving the recording device and the recording medium relative to each other in the sub-scanning direction to control the recording device to discharge the liquid from at least two of the plurality of recording elements, in accordance with at least two times of the main scanning control performed at positions on the recording medium in the sub-scanning direction, to record an image on the recording medium, and
performing the main scanning control for discharging the liquid from each of the plurality of sub-recording element groups based on discharge order mask patterns different from each other in a plurality of regions in the main scanning direction.
